(19) United States
(12) Patent Application Publication
(10) Pub. No.: US 2022/0051021 A1
(43) Pub. Date: Feb. 17, 2022

(54) AUGMENTED REALITY SYSTEM AND METHOD FOR REAL-TIME MONITORING OF USER ACTIVITIES THROUGH EGOCENTRIC VISION

(71) Applicant: Zensar Technologies Limited, Pune (IN)

(72) Inventor: Vidhi Sandeep Rai, Pune (IN)

(21) Appl. No.: 17/218,595

(22) Filed: Mar. 31, 2021

(30) Foreign Application Priority Data
Aug. 13, 2020 (IN) 202021034784

(51) Int. Cl. G06K 9/00

(52) U.S. Cl. CPC G06K 9/00671; G06K 9/00718; G06K 9/00744; G06K 9/00684

(57) ABSTRACT

An augmented reality based system and an augmented reality based method for monitoring user activities in a real-time in which the system includes eyewear having an egocentric image capturing means. A processor and memory are in communication with the egocentric image capturing means. The system captures activities of a user via the egocentric image capturing means to generate activity profile of the user. Further processes the activity profile of the user using trained neural network in order to derive a useful activity recognition profile comprising a set of targeted activities to be monitored for the user. The system analyses each set of targeted activities based upon predefined factors to categorize each of the set of targeted activities into a category of a predefined categories. The system derives insights to the user based upon the analysis of the targeted activities by artificial intelligence engine.

### CROSS-REFERENCE T RELATED APPLICATIONS AND PRIORITY

The present application claims priority from the Indian patent application number 202021034784 filed on 13 Aug. 2020.

### TECHNICAL FIELD

The present subject matter described herein, in general, relates to tracking daily activities of a user and enabling augmented reality visualization. More particularly, the invention relates to an augmented reality based system and method for real-time monitoring of user activities through egocentric vision.

### BACKGROUND

In the recent past, significant part of population of the world have been diagnosed with various allergies and illnesses, possibly due to change in daily routine and/or lifestyle of the people. Thus, off late, people have become more pre-emptive about their health care in terms of exercise, food consumption, maintaining balanced lifestyle etc. and therefore are exploring various options that could rack their daily activities in order to obtain personal health analysis.

In the existing art, there are a lot of electronic gadgets available which facilitates in analysing the activities of an individual. For example, these gadgets enable tracking fitness exercises, eating habits, and daily routine etc. of the individual. However, these gadgets have various drawbacks/limitations. Firstly, the tracking by these existing gadgets is not proactive and requires tracking to be initiated by the input received from the user and/or the inertial measurements. Secondly, these existing gadgets end up in tracking irrelevant actions/behaviour of the user which might not be useful in the intended purpose of such tracking. This results in lack of optimum utilization of resources such as storage devices and processing devices in the electronic gadgets for storing and processing data associated to the tracking irrelevant actions/behaviour of the user. Thirdly, the existing gadgets lack in providing any recommendations pertaining to improvements for the user pertaining to activities being tracked. Further, the existing gadgets fail to detect and notify threat to the user thereby failing to ensure personal safety of the user.

### SUMMARY

This summary is provided to introduce the concepts related to an augmented reality based system and method for real-time monitoring of user activities through egocentric vision and the concepts are further described in the detail description. This summary is not intended to identify essential features of the claimed subject matter nor it is intended to use in determining or limiting the scope of claimed subject matter.

In one implementation, the present subject matter describes an augmented reality based system for real-time monitoring of user activities through egocentric vision. The system may comprise a pair of eyewear further comprising an egocentric image capturing means. The system may further comprise a processor, in communication with the egocentric image capturing means, and a memory coupled with the processor. The processor may be configured to execute programmed instructions stored in the memory. In this implementation, the processor may be configured to execute programmed instructions for capturing, in a real-time, a plurality of activities of a user via the egocentric image capturing means in order to generate an activity profile of the user. The processor may further be configured to execute programmed instructions for processing the activity profile of the user in a real-time using a trained neural network in order to derive a useful activity recognition profile of the user, wherein the useful activity recognition profile comprises a set of targeted activities to be monitored for the user. Further, the processor may be configured to execute programmed instructions for analyzing each of the set of targeted activities based upon a plurality of predefined factors to categorize each of the set of targeted activities into a category of a plurality of predefined categories using an artificial intelligence engine. Furthermore, the processor may be configured to execute programmed instructions for deriving one or more insights to the user in real-time based upon the analysis and the category of the one or more targeted activities of the user by the artificial intelligence engine.

In another implementation, the present subject matter describes a method implemented by an augmented reality based system for real-time monitoring of user activities through egocentric vision. The method may comprise capturing, by a processor, in a real-time, a plurality of activities of a user via an egocentric image capturing means in order to generate an activity profile of the user. The method may further comprise processing, by the processor, the activity profile of the user in a real-time using a trained neural network in order to derive a useful activity recognition profile of the user, the useful activity recognition profile comprising a set of targeted activities to be monitored for the user. The method may further comprise analyzing each of the set of targeted activities based upon a plurality of predefined factors to categorize each of the set of targeted activities into category of a plurality of predefined categories using an artificial intelligence engine. The method may comprise deriving, by the processor, one or more insights to the user in real-time based upon the analysis and the category of the one or more targeted activities of the user by the artificial intelligence engine.

### BRIEF DESCRIPTION OF DRAWINGS

The detailed description is described with reference to the accompanying figures. In the Figures, the left-most digit(s) of a reference number identifies the Figure in which the reference number first appears. The same numbers are used throughout the drawings to refer like features and components.

FIG. 1 illustrates an implementation (100) of an augmented reality based system (101) for real-time monitoring of user activities through egocentric vision, in accordance with an embodiment of the present subject matter.

FIG. 2 illustrates a perspective view (200) of a pair of eyewear (111), in accordance with an embodiment of the present subject matter.

FIG. 3 illustrates a functional flow architecture (300) of an artificial intelligence (AI) engine for monitoring and visualizing augmented reality (AR) activities, in accordance with an embodiment of the present subject matter.

FIG. 4 illustrates a flow diagram (400) depicting steps performed by the augmented reality based system (101) for real-time monitoring of user activities through egocentric vision, in accordance with an embodiment of a present subject matter.

FIG. 5 illustrates a method (500) implemented by an augmented reality based system (101) for real-time monitoring of user activities through egocentric vision, in accordance with the embodiment of the present subject matter.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

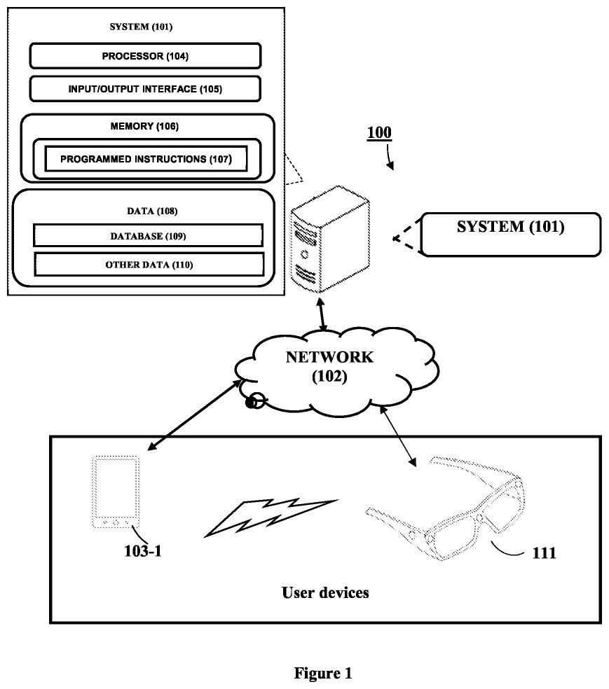

FIG. 1 illustrates an implementation of an augmented reality based system (100), hereinafter referred to as system (100) interchangeably, for real-time monitoring of user activities through egocentric vision, in accordance with an embodiment of a present subject matter. In accordance with aspects of the present subject matter, the system (100) is enabled to improve societal health and wellness using the augmented reality environment. Previous researches have shown a strong co-relation between daily activities of a person and health conditions. Poor health care can lead to increased risk of poor health conditions such as obesity as well as chronic diseases such as cardiovascular disease and diabetes. In order to prevent such risks, the system (100) is configured to provide egocentric vision based activity tracking of the user and augmented reality (AR) data visualization assistance to the user for health monitoring, lifestyle tracking and personal safety monitoring of the user.

In one embodiment, the augmented reality based system (100) may include a computing system (101), a network and one or more user device(s) (103). The computing system (101) may be connected to the user devices (103) over the network (102). It may be understood that the computing system (101) may be accessed by multiple users through one or more user devices (103-1), (103-2), (103-3) . . . (103-n), collectively referred to as the user device (103) hereinafter, or user (103), or applications residing on the user device (103). In one embodiment, the user device (103) may also comprise a pair of eyewear (111). In alternative embodiments, the pair of eyewear (111) may be itself act as a standalone user device (as shown in FIG. 1) separate from the user device (103) or may be incorporated within the user device (103). In one embodiment, the pair of eyewear (111) may comprise an egocentric image capturing means. In one embodiment, the pair of eyewear (111) is an augmented reality (AR) headset. The user (103) may be any person, machine, software, automated computer program, a robot or a combination thereof. In one embodiment, the user device (103-1) and the pair of eyewear (111) may be used by a user of the computing system (101).

In an embodiment, the present subject matter is explained considering that the computing system (101) may be implemented in a variety of user devices, including but not limited to, server, a portable computer, a personal digital assistant, a handheld device, a mobile, a laptop computer, a desktop computer, a notebook, a workstation, a mainframe computer, and the like. In one embodiment, the augmented reality based system (101) may be implemented in a cloud-computing environment. Hereinafter, the computing system (101) will be referred to as a server (101) for the sake of brevity.

In an embodiment, the network (102) may be a wireless network such as Bluetooth, Wi-Fi, LTE and such like, a wired network or a combination thereof. The network (102) can be accessed by the user device (103) using wired or wireless network connectivity means including updated communications technology. In one embodiment, the network (102) can be implemented as one of the different types of networks, cellular communication network, Local Area Network (LAN), Wide Area Network (WAN), the internet, and the like. The network (102) may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network (102) may include a variety of network devices, including routers, bridges, servers, computing devices, storage devices, and the like. In some embodiments, the pair of eyewear (111) may be communicatively coupled to the user device 103-1 via a short range communication, including but not limited to, Bluetooth, Zigbee, Infrared, and NFC etc. Further, in some embodiments, the user device 103-1 and the pair of eyewear (111) may be communicatively coupled with the server (101) via a long range communication, including but not limited to, an internet, intranet, LAN, WAN, MAN, cellular communication etc.

In one embodiment, the pair of eyewear (111) comprises an egocentric image capturing means in order to leverage the egocentric vision. The egocentric vision may be used to track activities performed by the user. Based on the activities, the user may be able to track and monitor aspects like lifestyle, health and personal well-being. For instance, in various non-limiting examples, the user may be able to visualize how many steps he/she has walked, how many glasses of water they had, heartrate monitoring, the user may also be assisted while doing physical activities like workouts, running, etc.

Now, referring to FIG. 1, the components of the server (101) may include at least one processor (104), an input/output (I/O) interface (105), a memory (106), programmed instructions (107) and data (108). In one embodiment, the at least one processor (104) may be configured to fetch and execute computer-readable/programmed instructions (107) stored in the memory (106).

In one embodiment, the I/O interface (105) may be implemented as a mobile application or a web-based application and may further include a variety of software and hardware interfaces, for example, a web interface, a graphical user interface, image capturing means of the user device and the like. The I/O interface (105) may allow the server (101) to interact with the user devices (103). Further, the I/O interface (105) may enable the user device (103) to communicate with other computing devices, such as web servers and external data servers (not shown). The I/O interface (105) can facilitate multiple communications within a wide variety of networks and protocol types, including wired networks, for example, LAN, cable, etc., and wireless networks, such as WLAN, cellular, or satellite. The I/O interface (105) may include one or more ports for connecting to another server.

In an implementation, the memory (106) may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and memory cards. The memory (106) may include programmed instructions (107) and data (108).

In one embodiment, the data (108) may comprise a database (109), and other data (110). The other data (110), amongst other things, serves as a repository for storing data processed, received, and generated by the one or more of the programmed instructions (107).

The aforementioned computing devices may support communication over one or more types of networks in accordance with the described embodiments. For example, some computing devices and networks may support communications over a Wide Area Network (WAN), the Internet, a telephone network (e.g., analog, digital, POTS, PSTN, ISDN, xDSL), a mobile telephone network (e.g., CDMA, GSM, NDAC, TDMA, E-TDMA, NAMPS, WCDMA, CDMA-2000, UMTS, 3G, 4G), a radio network, a television network, a cable network, an optical network (e.g., PON), a satellite network (e.g., VSAT), a packet-switched network, a circuit-switched network, a public network, a private network, and/or other wired or wireless communications network configured to carry data. Computing devices and networks also may support wireless wide area network (WWAN) communications services including Internet access such as EV-DO, EV-DV, CDMA/1×RTT, GSM/GPRS, EDGE, HSDPA, HSUPA, and others.

The aforementioned computing devices and networks may support wireless local area network (WLAN) and/or wireless metropolitan area network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others. Computing devices and networks also may support short range communication such as a wireless personal area network (WPAN) communication, Bluetooth® data communication, infrared (IR) communication, near-field communication, electromagnetic induction (EMI) communication, passive or active RFID communication, micro-impulse radar (MIR), ultra-wide band (UWB) communication, automatic identification and data capture (AIDC) communication, and others.

In one embodiment, the system (100) may be configured to real-time monitor user activities through egocentric vision. Once the user registers with the server (101), the processor (104) may be configured to execute instructions to capture a plurality of activities of the user, in real-time, for generating an activity profile of the user. In one embodiment, the plurality of activities of the user may be actions of the user to perform exercises, cooking, driving, and the like. The plurality of activities of the user may be captured via the egocentric image capturing means on the pair of eyewear worn by the user. Further, the processor (104) may be configured to process the activity profile of the user in real-time using a trained neural network in order to derive a useful activity recognition profile of the user. The useful activity recognition profile may comprise a set of targeted activities to be monitored for the user. The processor (104) may be configured to analyse each of the set of targeted activities based upon a plurality of predefined factors. Each of the set of targeted activities may be categorized into a category of a plurality of predefined categories using an artificial intelligence engine. The processor (104) may be configured to derive one or more insights to the user in real-time based upon analysis and category of the targeted activities of the user using the artificial intelligence engine.

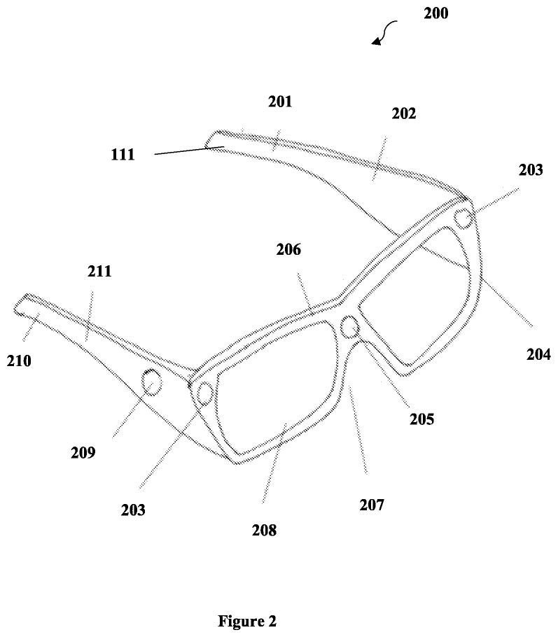

Referring to FIG. 2, a perspective view (200) of a pair of eyewear (111) is illustrated, in accordance with an embodiment of a present subject matter. In one embodiment, the pair of eyewear (111) may be an augmented reality (AR) headset which can be worn by the user on his eyes. The pair of eyewear (111) may comprise lithium-ion batteries (201), a GPS/GLONASS Bluetooth component (202), one or more depth sensors (203), an operating system (204), an egocentric RGB camera (205), a plurality of sensors (206) such as IMY, pressure, humidity, heart rate and such like, a noise cancellation mic (207), an AR-enabled display technology (208), a multi-purpose touch button (209), a USB connectivity (210) and a processor RAM storage (211). In one embodiment, the egocentric image capturing means may be the egocentric camera (205). The egocentric camera (205) may be configured for capturing a plurality of image frames associated to the line of sight of the user interchangeably referred to as an egocentric vision which is the first-person view. It is to be noted herein that the egocentric vision provides a view of daily activities of the user offering a visual story of the user behavior. It must be noted that the real world is three-dimensional, the data captured by the egocentric camera (205) may be trapped on two-dimensional screen. The lithium-ion batteries (201) may provide charge that may support the pair of eyewear (111) for a period of up to 24 hours and reverse charge through the processor. The GPS/GLONASS/Bluetooth component (202) may be configured to provide wireless connectivity with the user device (103-1). The one or more depth sensors (203) may be configured to sense depth estimation of the environment which may enable in better detection of objects and activities of the user and also enable placing augmented reality (AR) objects in real-time. In one embodiment, the depth sensors (203) may be configured to recognise hand gestures of the user. The operating system (204) may be configured to perform all the basic tasks like file management, memory management, process management, handling input and output, and controlling peripheral devices. The egocentric camera (205) may monitor user actions and daily activities. The plurality of sensors (206) may be configured to sense corresponding parameters of the user such as motion of the user, heart rate of the user, and the like. The noise cancellation mic (207) may be used for receiving voice commands from the user. The augmented reality (AR)-enabled display technology (208) may be developed by Augmented Reality software development kits like, but may not be limited to, ARKit, ARCore etc. The technical details of AR technology is well known in the art and therefore not described herein. The multi-purpose touch button (209) may be provided to operate the pair of eyewear (111) based on user selection, if required. The USB connectivity (210) and the processor RAM storage (211) may facilitate transmission of long streams of data back-and-forth between the user device (103-2) and the pair of eyewear (111). In one embodiment, the pair of eyewear (111) may be interfaced with user device (103-4) which may eliminate memory and processing constraints unlike smart glasses existing in the market which rely on computational limitations. The processor RAM storage (211) may be a standalone processing block, either embedded in the pair of eyewear (111) or a high-end mobile phone that runs the real-time analysis on the camera feed and communicates with the augmented reality based system (101).

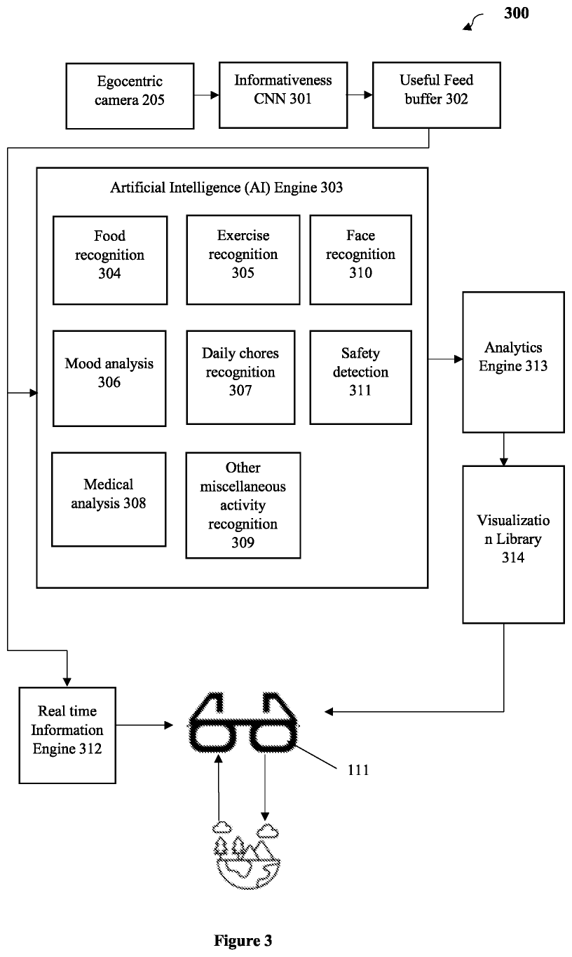

FIG. 3 illustrates a functional flow architecture (300) of an artificial intelligence (AI) engine for monitoring and visualizing augmented reality (AR) activities, in accordance with an embodiment of a present subject matter. In one embodiment, an egocentric feed received from the egocentric image capturing means (205) may be analysed by the trained neural network associated with the processor (211) of the pair of eyewear (111).

The trained neural network is an informativeness convolution neural network pre-trained on a plurality of image frames of the activities that need to be identified in the egocentric feed. The activities may comprise, but are not be limited to, tying shoelaces which may imply the user is going out for a run or to the gym, pouring water in a kettle which may imply the user is making a hot beverage like tea or coffee, and such like. The trained neural network may be configured for segregating a plurality of frames from the egocentric feed and determine a plurality of useful frames (302) from the plurality of frames. The plurality of useful frames (302) may be determined based upon training data of the trained neural network and one or more sensor values captured from one or more sensors (206) in communication with the processor (211). The plurality of useful frames (302) may be transmitted to an artificial intelligence engine (303).

The artificial intelligence engine (303) is configured for determining the plurality of useful frames. It may be noted that plurality of useful frames may be determined based upon the trained neural network along with the one or more sensor values captured from the one or more sensors (206). In one embodiment, the plurality of useful frames comprises a set of target activities to be monitored for the user. In an embodiment, each of the set of targeted activities may be analyzed based upon the plurality of predefined factors to categorize each of the set of targeted activities. The plurality of predefined factors may at least include, but are not be limited to, one or more of surroundings, time of the day, color and texture of one or more objects in consideration, and one or more sensor values. The set of targeted activities may comprise, but are not be limited to, holding a glass of liquid may imply that the user is having a beverage, wherein the beverage may be alcoholic, tea, coffee, soft drink and such like. The artificial intelligence (AI) engine 303 may be configured to derive the useful activity recognition profile of the user based upon the plurality of useful frames. In one embodiment, the artificial intelligence engine (303) may be configured to perform food recognition (304), exercise recognition (305), mood analysis (306), daily chores recognition (307), medical analysis (308), other miscellaneous activity recognition (309), face recognition (310), and safety recognition (311).

Further, the artificial intelligence engine (303) may facilitates in deriving the insights from one or more sensors (206), a visualization library (314), an intelligent search engine (313). The insights derived may be capable of extracting information from internet in real-time, or combinations thereof. The real-time information engine (312) may be configured to extract information. The insights derived may be rendered to the user on a display of the augmented reality system (208) present on the pair of eyewear (111). The insights may include, but are not be limited to, recommendation of online videos for recipes is displayed, when the user is cooking or workout videos is displayed, when the user is working out (i.e. performing fitness exercise), and the like.

In one embodiment, the artificial intelligence engine (303) may be further configured for identifying presence of at least one anomaly corresponding to the user and notifying presence of the at least one anomaly to the user and one or more emergency contacts. In one embodiment, the anomaly may be, but are not be limited to, a person attacking the user, accident detection, and the like.

In one exemplary embodiment, the user is performing an activity of cooking. The egocentric camera (205) and the one or more sensors (206) of the pair of eyewear (111) may capture the actions of the user. This received egocentric feed may be analysed by the trained neural network. The trained neural network may be configured to segregate a plurality of frames from the egocentric feed to determine a plurality of useful frames, In this exemplary embodiment, consider that while turning on the gas or taking a utensil, the user may pick up a wrapper from the floor, then such a frame of the picking a wrapper from floor may be differentiated from the frames such as turning on gas and taking a utensil. Thus, all such frames depicting action of cooking are segregated as useful frames. The plurality of useful frames may be transmitted to the artificial intelligence (AI) engine in the user device. The artificial intelligence engine may be configured to determine the activity of cooking based on a plurality of predefined factors such as identifying a kitchen, the time of cooking, ingredients used, and the like. The activity determined may be categorized as cooking a curry. Thus, the artificial intelligence engine may be configured to recommend the recipes of various curries to the user on the display of the augmented reality system (208). Such a recommendation may be an insight for the user.

In another exemplary embodiment, consider the user is performing an activity of fitness exercise. The egocentric camera (205) and the one or more sensors (206) of the pair of eyewear (111) may capture the actions of the user. This received egocentric feed may be analysed by the trained neural network. The trained neural network may be configured to segregate a plurality of frames from the egocentric feed to determine a plurality of useful frames. In this exemplary embodiment, consider that while stepping on the treadmill and then running on it, simultaneously the user talking with another person, then such a frame of talking to a person may be differentiated from the frames such as stepping on the treadmill and then running on it. Thus, all such frames depicting actions of exercising are segregated as useful frames. The plurality of useful frames may be transmitted to the artificial intelligence (AI) engine in the user device. The artificial intelligence engine may be configured to determine the activity of exercising based on a plurality of predefined factors such as wearing shoes, speed of running, and the like. The activity determined may be categorized as performing cardio exercise. Thus, the artificial intelligence engine may be configured to display summarized data to the user on the display of the augmented reality system (208), wherein the summarized data may include user's running speed, running distance, time taken to reach the running distance, calories burned, present weight, and the like.

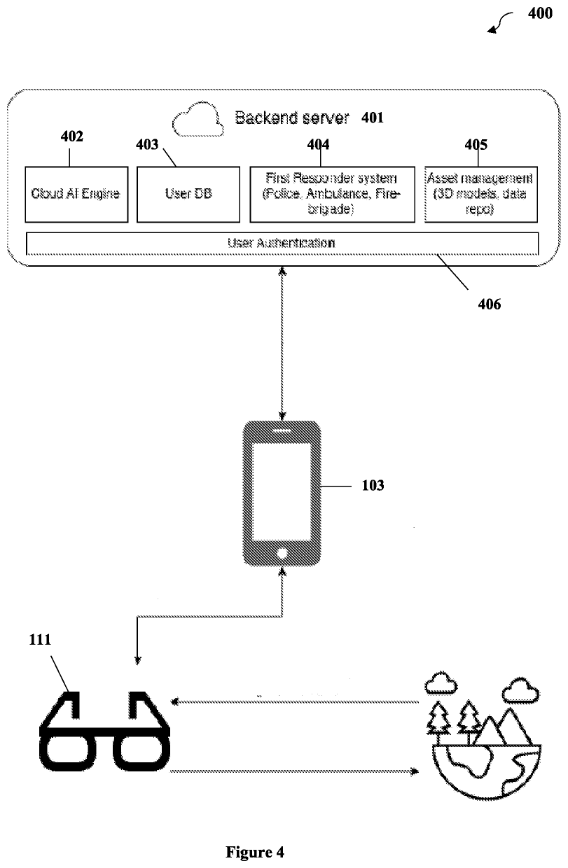

Now referring to FIG. 4, a flow diagram (400) depicting steps performed by the augmented reality based system (101) for real-time monitoring of user activities through egocentric vision is depicted, in accordance with an embodiment of a present subject matter. In one embodiment, the server (101) shown as a backend server (401) may comprise a cloud AI engine 402, a user database (DB) (403), and a first responder system (404). The first responder system (404) may comprise police, ambulance, fire brigade and such like, and asset management (405). The asset management (405) may comprise 3D models, data repository and such like. When a user wears the pair of eyewear (111), the pair of eyewear (111) may be configured to understand the environment using the depth sensors (203) and the egocentric camera (205). The frames analysed by the pair of eyewear (111) may be transmitted to the user device (103). The processor (211) of the user device may be configured to perform first level of activity recognition. The backend server (401) may be configured to receive the user data and perform the targeted activity recognition of the user. The backend server (401) may be configured to deliver deferred analytics, historical data, alerts, and the like through the user device (103) to the pair of eyewear (111). The augmented reality enabled display technology (208) may be configured to display the delivered insights to the user.

It is an established fact that the user's body continuously radiates data on the daily basis. More specifically, the user's body radiates data such as heartbeats, breathe, motion, and the like. The automatic tracking of daily activities of the user in order to realise daily fitness goals of the user is facilitated by the server (101) in combination with the plurality of inputs received from the pair of eyewear (111) and the processed data from the user device (103-1). In one embodiment, the augmented reality based visualization in the user's view of the real world may reduce the mental efforts needed to connect digital information about the physical world. The augmented reality headset may enable the user to visualize data more effectively and find out ways to improve user activities and eventually health of the user.

The augmented reality based system (101) is configured for egocentric vision-based activity recognition which is far more accurate than the other wearable devices that rely on either user's input or inertial measurements. Based on the activity recognition the augmented reality based system (101) may enable in personal well-being, health tracking, fitness tracking and personal safety of the user. Health and fitness tracking include detecting the kind of activity the user is doing such as gym, cardio, sport etc. and analyzing the health benefits. The augmented reality based system (101) may be configured to detects daily chores and create an AR graphical visualization summary illustrating working hours, working out, cleaning, driving etc. The augmented reality based system (101) may be configured for providing personal safety by threat detection. If in an egocentric vision, the augmented reality based system (101) may detect a threat to life of the user for example, someone attacking the user, accident detected etc., the system (101) may automatically inform emergency contacts, nearby hospitals, and police stations. The system (101) may be configured to provide personal wellbeing by silencing all the distractions when any assiduous activity is being performed by the user such as driving and informing the user to take a walk when he's working on the computer for a longer duration. The system (101) may also perform food recognition that may detect the number of calories the person is intaking daily. The system (101) may enable in detection of diseases in early stages based on collected data.

The visual aid in the form of augmented reality display may overlay digital elements which may improve how the user perceives analysed data. The health and fitness data such as tracked and analysed data, graphs, etc. may be displayed on the user's view of the real-world using augmented reality display. The user may ask for certain activity demonstration in the augmented reality display for example. 3D animation of bench press can be played in the augmented reality display.

In one embodiment, the system (101) may be used as a life-logging device for people with Amnesia or Alzheimers helping them with AR-based visual aid at the same time. The system (101) may be programmed to detect migraine triggers for patients.

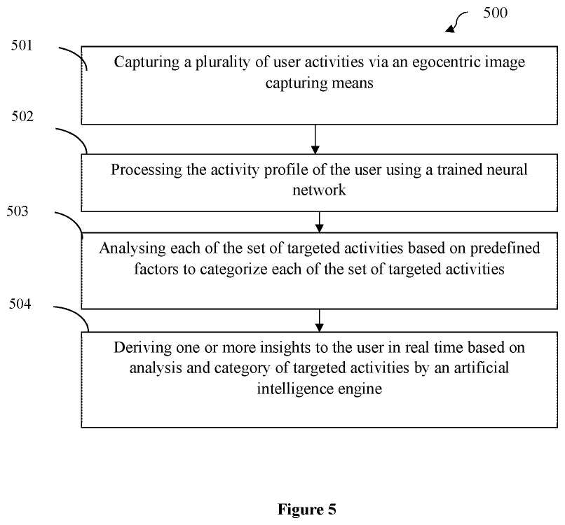

Now referring to FIG. 5, a method (500) implemented by an augmented reality based system (101) for real-time monitoring of user activities through egocentric vision is illustrated, in accordance with the embodiment of the present subject matter.

At step (501), a plurality of user activities may be captured via an egocentric image capturing means in order to generate an activity profile of the user via the processor (104)

At step (502), the processor (104) may be configured for processing, the activity profile of the user in a real-time using a trained neural network in order to derive a useful activity recognition profile of the user. The useful activity recognition profile may comprise a set of targeted activities to be monitored for the user.

At step (503), each of the set of targeted activities may be analysed via processor (104) based upon a plurality of predefined factors. Each of the set of targeted activities may be categorized into category of a plurality of predefined categories using an artificial intelligence engine.

At step (504) the processor (104) may be configured for deriving one or more insights to the user in real-time based upon the analysis and the category of the one or more targeted activities of the user by the artificial intelligence engine.

The embodiments, examples and alternatives of the preceding paragraphs or the description and drawings, including any of their various aspects or respective individual features, may be taken independently or in any combination. Features described in connection with one embodiment are applicable to all embodiments, unless such features are incompatible.

Although implementations for the an augmented reality based system and method for real-time monitoring of user activities through egocentric vision have been described in language specific to structural features and/or methods, it is to be understood that the appended claims are not necessarily limited to the specific features or methods described. Rather, the specific features and methods are disclosed as examples of implementations for the augmented reality based system and method for real-time monitoring of the user activities through egocentric vision.

1. An augmented reality based system for real-time monitoring of user activities through egocentric vision, the augmented reality based system comprising:
a pair of eyewear comprising an egocentric image capturing means;
a processor in communication with the egocentric image capturing means; and
a memory coupled with the processor, wherein the processor is configured to execute programmed instructions stored in the memory, the programmed instructions comprising instructions for:
capturing, in a real-time, a plurality of activities of a user via the egocentric image capturing means in order to generate an activity profile of the user;
processing the activity profile of the user in a real-time using a trained neural network in order to derive a useful activity recognition profile of the user, the useful activity recognition profile comprising a set of targeted activities to be monitored for the user;
analyzing each of the set of targeted activities based upon a plurality of predefined factors to categorize each of the set of targeted activities into a category of a plurality of predefined categories using an artificial intelligence engine; and
deriving one or more insights to the user in real-time based upon the analysis and the category of the one or more targeted activities of the user by the artificial intelligence engine.

2. The augmented reality based system as claimed in claim 1, wherein the egocentric image capturing means comprises an egocentric camera configured for capturing a plurality of image frames associated to the line of sight of the user.

3. The augmented reality based system as claimed in claim 1, wherein the trained neural network is an informativeness convolution neural network, and wherein the said informativeness convolution neural network is pre-trained on a plurality of image frames of the activities that are to be identified.

4. The augmented reality based system as claimed in claim 3, wherein the trained neural network is configured for:
analysing an egocentric feed received from the egocentric image capturing means;
segregating a plurality of frames from the egocentric feed;
determining a plurality of useful frames from the plurality of frames based upon training data of the trained neural network and one or more sensor values captured from one or more sensors in communication with the processor;
deriving the useful activity recognition profile of the user based upon the plurality of useful frames;
identifying presence of at least one anomaly corresponding to the user; and
notifying presence of the at least one anomaly to the user and one or more emergency contacts.

5. The augmented reality based system as claimed in claim 1, wherein the artificial intelligence engine is configured for analysing the plurality of useful frames received from the trained neural network in combination with the one or more sensor values captured from the one or more sensors in order to analyze the one or more targeted activities based upon the plurality of predefined factors to categorize each of the set of activities, and wherein the plurality of predefined factors at least include one or more of surroundings, time of the day, color and texture of one or more objects in consideration, and one or more sensor values.

6. The augmented reality based system as claimed in claim 1, wherein the insights are derived from one or more sensors, a visualization library, an intelligent search engine capable of extracting information from internal in real-time, or combinations thereof, and wherein the insights derived are rendered to the user on a display of the augmented reality system.

7. An augmented reality based method for real-time monitoring of user activities through egocentric vision, the augmented reality based method comprising:
capturing, by a processor, in a real-time, a plurality of activities of a user via an egocentric image capturing means in order to generate an activity profile of the user;
processing, by the processor, the activity profile of the user in a real-time using a trained neural network in order to derive a useful activity recognition profile of the user, the useful activity recognition profile comprising a set of targeted activities to be monitored for the user;
analyzing, by the processor each of the set of targeted activities based upon a plurality of predefined factors to categorize each of the set of targeted activities into category of a plurality of predefined categories using an artificial intelligence engine; and
deriving, by the processor, one or more insights to the user in real-time based upon the analysis and the category of the one or more targeted activities of the user by the artificial intelligence engine.

8. The augmented reality based method as claimed in claim 7, wherein the processing of the activity profile of the user using the trained neural network comprises:
analysing an egocentric feed received from the egocentric image capturing means;
segregating a plurality of frames from the egocentric feed;
determining a plurality of useful frames from the plurality of frames based upon training data of the trained neural network and one or more sensor values captured from one or more sensors in communication with the processor;
deriving the useful activity recognition profile of the user based upon the plurality of useful frames;
identifying, presence of at least one anomaly corresponding to the user; and
notifying, presence of the at least one anomaly to the user and one or more emergency contacts.

9. The augmented reality based method as claimed in claim 8, wherein the artificial intelligence engine is configured for analysing the plurality of useful frames received from the trained neural network in combination with the one or more sensor values captured from the one or more sensors in order to analyze the one or more targeted activities based upon the plurality of predefined factors to categorize each of the set of activities, wherein the plurality of predefined factors at least include one or more of surroundings, time of the day, color and texture of one or more objects in consideration, and one or more sensor values.

10. The augmented reality based method as claimed in claim 9, wherein the insights are derived from one or more sensors, a visualization library, an intelligent search engine capable of extracting information from internet in real-time, or combinations thereof, and wherein the insights derived are rendered to the user on an augmented reality display system.
